(19) United States
(12) Patent Application Publication
(10) Pub. No.: US 2010/0238282 A1
(43) Pub. Date: Sep. 23, 2010

(54) Matrix Lighting System, Particularly of the Scialytic Type, Method for Controlling Such Lighting and Method for Calibrating a Camera Fitted on Said System

(75) Inventors: Jacques Cinqualbre, Rosheim (FR); Thierry Collette, Palaiseau (FR); Laurent Letellier, Verrieres Le Buisson (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignees: Jancques Cinqualbre, Rosheim (FR); Commissariat a L'Energie Atomique, Paris (FR)

(21) Appl. No.: 12/530,746

(22) PCT Filed: Mar. 10, 2008
(86) PCT No.: PCT/EP08/52806

§ 371 Date: May 26, 2010

(30) Foreign Application Priority Data
Mar. 13, 2007 (FR) 07/01798

(51) Int. Cl. H04N 7/18; H05B 37/02; G10L 21/00; H04N 17/00

(52) U.S. Cl. 348/135; 315/153; 704/275; 348/187; 348/E07.085

(57) ABSTRACT

The matrix lighting system comprises an array of lighting sources that are activated by a power supply system provided with a processing means. It also comprises at least one camera and an object having marks characterizing the position and the orientation of the object in space, an area to be lit being designated according to the orientation of the object, the camera capturing the images of the object and transmitting them to the processing means which compute the space coordinates of the marks, the power supply system activating the lighting sources according to the position and the orientation of the object that are defined by the marks. The invention applies notably to shadowless lamps meeting the lighting requirements in the medical field.

### CROSS-REFERENCE TO RELATED APPLICATIONS

This application is a national phase application “371” of PCT/EP2008/052806 filed Mar. 10, 2008, which claims priority of FR07/01798 filed Mar. 13, 2007, the entire contents of both applications are incorporated herein by reference in their entireties.

### FIELD OF INVENTION

The present invention relates to a matrix lighting system and to a method of controlling an array of lighting sources. It also relates to a method of calibrating a camera with which a matrix lighting system is equipped.

The invention applies notably to scialytic or shadowless lamps meeting the lighting requirements in the medical field.

### DESCRIPTION OF PRIOR ART

The lighting requirements in the medical field relate notably to:
equipment for operating theaters;
equipment for obstetric units;
equipment for examination rooms in general, such as for example rooms reserved for emergencies or for dermatology;
equipment for dental surgeries;
equipment for veterinary clinics.

Shadowless lamps are generally made up of a main lighting unit which may or may not be accompanied by a satellite lighting unit enabling light to be added if necessary. These lighting units are of the ceiling-mounted type, but there are also wall-mounted or mobile lighting units, notably for the emergency and resuscitation services. The latter units are in general smaller in size.

The lighting units mainly consist of halogen lamps fitted with infrared filters and are cooled by air convection. The lamps are either placed centrally, forming central-lamp lighting units, or are placed in windows at defined angles of inclination, forming a multi-projector lighting unit.

At the present time, the system for orienting these lighting units is manual. A central joystick or lateral joysticks are used to position the lighting units. The bulkiest systems include counterweights so as to make them easier to manipulate.

These shadowless lamps therefore have to be manipulated, this being a tedious task notably for large systems, and not very precise. They do not always make it possible to light well-defined areas with specific lighting parameters, such as color temperature, intensity or direction for example.

### SUMMARY OF THE INVENTION

An objective of the invention is notably to allow the lighting provided by a shadowless lamp to be regulated without manipulating the lamp itself. For this purpose, one subject of the invention is a matrix lighting system comprising an array of lighting sources that are activated by a power supply system provided with a processing means, said system comprising at least one video sensor and a control object comprising marks characterizing the position and the orientation of the object in space, an area to be lit being designated according to the orientation of the object, the video sensor capturing the images of the object and transmitting them to the processing means which computes the space coordinates of the marks, the power supply system activating the lighting sources according to the position and the orientation of the object that are defined by the marks.

The object has, for example, an axis defining the orientation of the object, the area to be lit being pointed to by the straight line from the space coincident with the axis.

Advantageously, the object may be a stylus, the axis being the axis of the tip of the stylus. The position of the area to be observed is defined by the position of the tip of the stylus. The position of the tip of the stylus is notably known in a reference frame tied to the marks on the stylus.

The stylus has, for example, a plate on which the marks are placed, the plate being for example perpendicular to the axis of the tip of the stylus.

The marks are for example reflecting targets. Advantageously, the marks may be encoded, the encoding being a function of a given array of lighting sources.

Since the array of lighting sources is supported by a wall, the wall has for example an opening via which the sensor observes.

Advantageously, when the area to be lit has been designated, the regulating of the area may be controlled by means of a voice command transmitted to the system for activating the sources.

In another embodiment, when the area to be lit has been designated, the regulating of the area is controlled for example by means of an integrated interface on the object, the regulating command being transmitted to the system for activating the sources via the interface.

The array of lighting sources includes for example marks, the position of which is known in a reference frame tied to the array. The camera operates for example in the near infrared.

Another subject of the invention is a method of controlling an array of lighting sources that are activated by a power supply system provided with a processing means, said method using at least one video sensor and an object having marks characterizing the position and the orientation of the object in space, an area to be lit being designated according to the orientation of the object, the sensor capturing the images of the object and transmitting them to the processing means which computes the coordinates of the marks in a 3D reference frame tied to the sensor, the power supply system activating the lighting sources as a function of the position and the orientation of the object that are defined by the marks.

Another subject of the invention is a method of calibrating a video sensor with which an array of lighting sources activated by a power supply system provided with a processing means is equipped, said system comprising at least the sensor and an object having marks characterizing the position and the orientation of the object in space, an area to be lit being designated according to the orientation of the object, the sensor capturing the images of the object and transmitting them to the processing means which computes the space coordinates of the marks with respect to a reference frame tied to the sensor, the power supply system activating the lighting sources according to the position and the orientation of the object that are defined by the marks, said calibration method comprising:

a phase during which the sensor points to a test pattern equipped with marks, the position of these marks in space being known relative to a reference frame tied to the test pattern, making it possible to determine the transformation parameters Rcm, Tcm in order to switch from the reference frame of the test pattern to the reference frame of the sensor;

a phase during which another video sensor points to the marks, the position in space of which is known relative to a reference frame tied to the array of lighting sources, the other sensor also pointing to the marks of the test pattern, making it possible to determine the transformation parameters Rms, Tms for switching from the reference frame tied to the test pattern to the reference frame tied to the array of lighting sources; and

a phase for composing the two aforementioned transformations Rcm, Tcm, Rms, Tms for switching from the reference frame tied to the sensor to the reference frame tied to the array of lighting sources.

This method of calibration is for example to be applied for each of the video sensors used.

Notably, the main advantages of the invention are that it improves the instrument sterilization conditions, it dispenses with the use of a motor-driven system for moving the light sources, and it makes it possible to define the geometry of an area to be lit, the lighting conditions and, if necessary, to specify several lighting areas.

### BRIEF DESCRIPTION OF THE DRAWINGS

Other features and advantages of the invention will become apparent from the following description, in conjunction with the appended drawings which show:

FIG. 1, an illustration of the main functional units of a system according to the invention;

FIG. 2, one possible embodiment of a matrix lighting system;

FIG. 3, one possible embodiment of an object for controlling the lighting according to the invention;

FIG. 4, an illustration of the switching from a reference frame tied to a video camera system, used in a system according to the invention, to a reference frame tied to an array of lighting sources forming the matrix lighting; and

FIG. 5, an example of the implementation of a calibration method according to the invention, for a camera used in a system according to the invention.

### MORE DETAILED DESCRIPTION

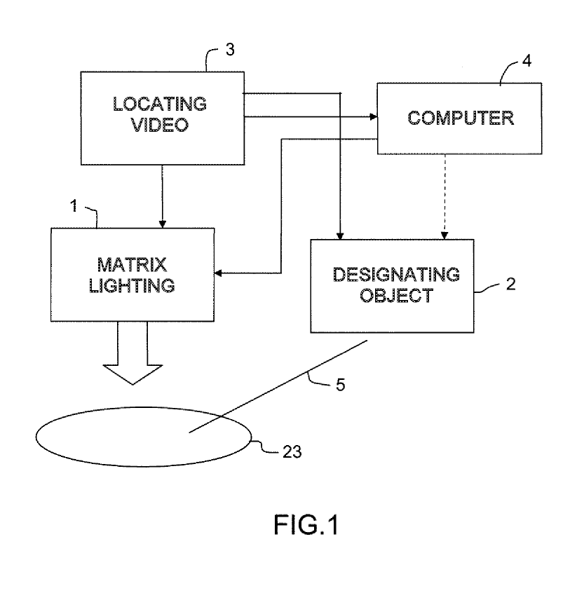

FIG. 1 shows the main functional units 1, 2, 3, 4 of a system according to the invention. The system comprises, for example, at least:
a matrix lighting system 1 of the type comprising an array of lighting sources, especially of the shadowless type;
an object 2 for controlling the lighting, this object designating a straight line 5 in space, this straight line itself designating an area 23 to be lit;
a system 3 for locating the object 5 in space, using notably a camera; and
a computer 4 or any other processing means.

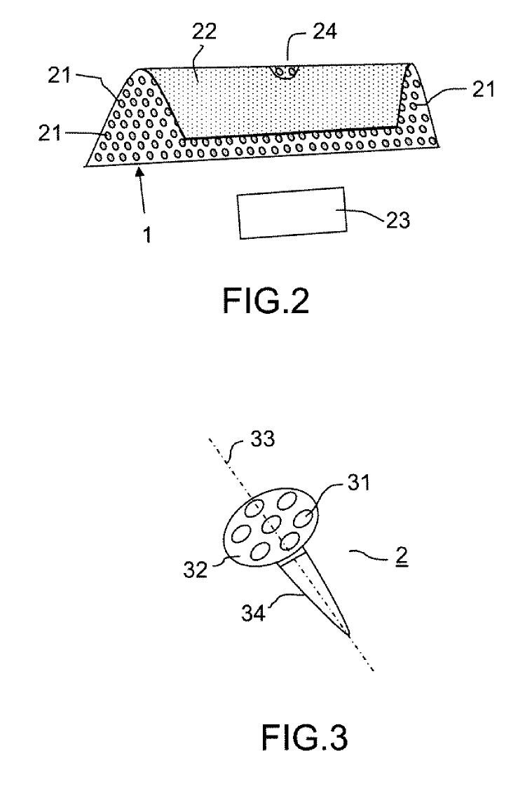

FIG. 2 illustrates one possible embodiment of the matrix lighting system 1 of the shadowless type. The matrix lighting unit is made up of individual lighting sources 21 that can be individually controlled. These sources 21 may therefore notably be turned on or off one by one, or in groups. The lighting sources are for example light-emitting diodes or bulbs.

Since the lighting system of FIG. 2 is of the shadowless type, it comprises a wall 22 on which the individual lighting sources 21 are placed. The shape of the wall 22 must notably allow the light rays produced by the sources 21 to converge on the area 23 to be lit, or possibly on several areas to be lit. The wall may therefore adopt several shapes. These shapes are for example toric, hemispherical or even of the inclined-plane type. Other shapes are possible depending on the requirements.

An opening 24 is for example provided in the wall so as to provide a passage for a video camera. More particularly, this opening is located in the field of the camera.

The lighting sources 21 are supplied with energy by a power supply system enabling each source to be individually powered. This system may be of the wire type or printed-circuit type. Each source is referenced by a position x, y on the wall. The position x, y and the orientation of each source are known by construction. The computer 4 determines for example the sources to be lit according to the designation of an area to be lit and its light intensity. The computer can therefore determine, according to the shape of the wall 22 and the position and orientation of the lighting sources 21 known by construction, the sources to be activated so as to light a given area 23.

FIG. 3 illustrates one possible embodiment of the object 2 for controlling the lighting. More particularly, FIG. 2 shows a control stylus provided with backreflecting targets 31. These targets 31 can be very easily located by a camera, under incident lighting. The targets lie on a plane 32 having a given direction relative to the axis 33 of the tip 34 of the stylus 2. The back reflecting targets are for example placed on a plate 32 perpendicular to the axis of the stylus. These targets thus make it possible to determine the position and the direction of the stylus defined by its axis 33, this axis being coincident with the straight line 5 designating the area to be lit.

When, in a preferred embodiment, the targets are circular, there are at least four of them so as to make it possible to determine the location and the direction of the stylus. However, to increase the precision of this determination, it may be advantageous to have a larger number of targets. In one particular embodiment, it is possible to use encoded targets, the encoding corresponding to a particular shadowless lamp. It may thus be advantageous to adapt the lighting control according to the shadowless lamp. Rectangular or square targets may also be used. In this case, a single target may suffice, the location and the direction of the stylus then being determined by detecting the four corners of the target. One method of locating an object bearing marks in space, such as for example the reflecting targets 31, is notably described in French patent application No. 2 760 277. More particularly, this method makes it possible to locate in space the marks relative to an image acquisition means, for example a camera.

The stylus may be passive or active. A passive stylus comprises only reflecting targets or any other marks that can be referenced by a video sensor. In this case, it may notably be easily sterilized. It is even possible to envisage a disposable stylus after each surgical intervention, in particular if the manufacturing cost is low.

An active stylus integrates notably electronic functions. In this case, it is for example provided with buttons, knurled wheels, liquid-crystal or other displays. It may also be fitted with a wireless transmission, for example of the bluetooth type. Thus, the operator can control the lighting directly via this interface, notably for regulating the intensity of the light or the boundaries of the area covered by the lighting.

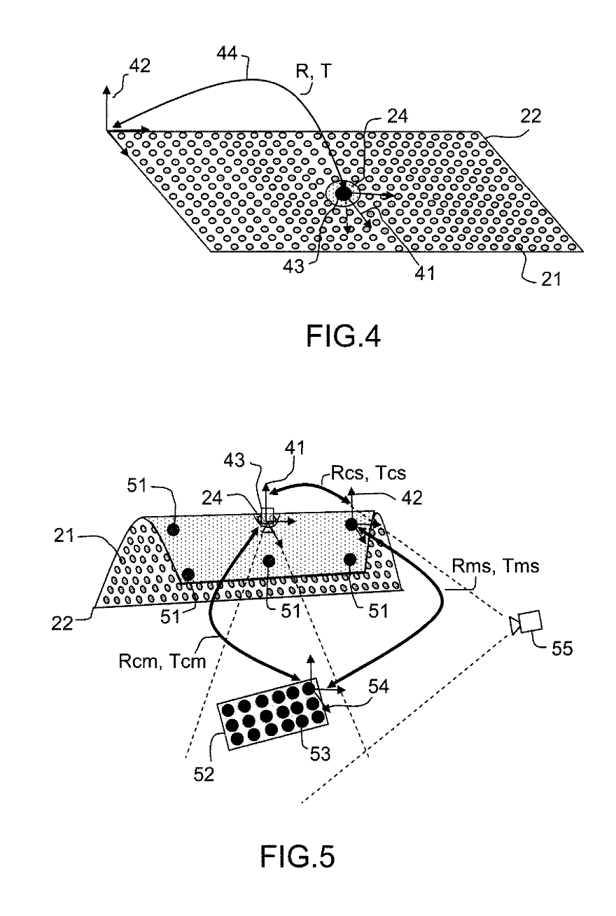

FIG. 4 illustrates the switching of a reference frame 41 tied to the video system 3 to a reference frame 42 tied to the shadowless lamp and more particularly to the wall 22 supporting the lighting sources 22. The wall is shown opened out, i.e. so as to be flat, seen from the side facing the light sources 21. A video camera 43 is placed opposite the opening 24 created in the wall, the camera being placed slightly above the wall. The video system may be made up of a single camera, but it may be advantageous to use several cameras notably to avoid possible masking that may occur as a result of the movement of individuals present during an intervention beneath the shadowless lamp.

The targets may be detected and then finally located in the video image by barycentric or more complex methods, such as those described in the aforementioned document No. 2 760 277.

To control the matrix lighting and to turn on the sources for the desired lighting, it is necessary to switch from the reference frame 41 of the camera to the reference frame 42 of the shadowless lamp. Specifically, the area to be lit is designated by the stylus, but in the reference frame of the camera. The spatial coordinates of the area to be lit must be transposed into the reference frame of the shadowless lamp in order to allow the computer 4 to determine the sources to be lit. As indicated above, it would be assumed that the position and the orientation of the lighting sources 21 are known in the reference frame of the shadowless lamp by construction. The transposition 44 of the space coordinates of the area may be carried out conventionally by a rotation R in three dimensions followed by a translation T in three dimensions, these two successive transformations being able to be expressed in matrix form corresponding to the three vectors of the translation T and to the three angles of the rotation R. From this matrix, the computer can determine the coordinates in the reference frame of the shadowless lamp and therefore the sources 31 to be activated.

FIG. 5 illustrates an example of the calibration of the camera 43 with which the shadowless lamp is equipped. The calibration of the camera notably makes it possible to better estimate the (R,T) transformation 44 for switching from the reference frame 41 of the camera to the reference frame 42 of the shadowless lamp. One objective is to determine the orientation and the position of the stylus in the reference frame of the lamp so as to determine the lighting sources to be activated. The calibration procedure may be carried out once and for all in the factory during manufacture of the complete system. The system comprises notably the actual shadowless lamp itself, essentially formed from the wall 22, equipped with the lighting sources 21 and the camera 43, fixed relative to the lamp.

In a first step, notably in the manufacturing process, it is possible to insert several targets 51 on the external face of the wall 22 opposite the lighting sources 21. These targets could also be placed on the opposite face, but would then take the place of lighting sources.

These targets are placed at locations known by construction. They may or may not be made of metal, they may have a circular or rectangular shape for example, and they may or may not be encoded. The position of these targets 51 is therefore known in the reference frame 42 of the shadowless lamp.

In a second step, the camera 43 of the shadowless lamp points at a known calibration test pattern 52. This test pattern comprises a number of targets 53, at least four. The positioning of these test patterns in space is also known in a reference frame 54 tied to the test pattern. From the known positions of the targets 53 notably in the reference frame 41 of the camera and from the same positions known in the reference frame 54 of the test pattern, it is thus possible in this second step to determine the six parameters Rcm₁, Rcm₂, Rcm₃, Tcm₁, Tcm₂, Tcm₃ of the transformation (Rcm, Tcm) that is used to switch from the reference frame of the test pattern to the reference frame of the camera 43 of the shadowless lamp.

In a third step, a second camera 55 points to the targets 51 of the lamp and the targets 53 of the test pattern, the positions of these targets 51, 53 being known in space. It is thus possible in this third step to determine the six parameters Rms₁, Rms₂, Rms₃, Tms₁, Tms₂, Tms₃ of the transformation (Rms, Tms) for switching from the reference frame 54 of the test pattern to the reference frame 42 of the lamp.

In a fourth step, by composing the two transformations (Rcm, Tcm) and (Rms, Tms), it is possible to determine the transformation 44 (Rcs, Tcs) for switching from the reference frame 41 of the camera 43 of the lamp to the reference frame 42 of the lamp.

In one embodiment of the shadowless lamp, it is possible to use preselected lighting sources instead of the targets 51 affixed on the lamp. In this case, the sources are activated so that they have the function described above of the targets 51. By construction, the position of these preselected sources is known in the reference frame of the lamp.

The video system may, in one particular embodiment, operate in the near infrared so as to detect only the targets 31 and therefore to provide more reliable detection, the environment external to the targets not being detected. In this case, a lighting unit in the near infrared, around a wavelength of the order of 1 μm, formed from a number of specific diodes, is for example placed around the camera. The latter is then fitted with a band-pass filter centered on the wavelength of the specific diodes.

In another embodiment, is it possible to increase the light of the shadowless lamp in the area of the targets 31 after first detection in order for said targets to be better delineated.

The interface with a user takes place by means of the stylus 2. Two interfacing modes are possible depending on whether the stylus is active or passive.

If the stylus is active, the interface may take place via the stylus, which then acts as a kind of three-dimensional mouse. The stylus designates the area to be lit, this area being referenced by the targets 31. The stylus is for example equipped with one or more buttons and with a liquid-crystal display LCD screen, the button or buttons then being associated with a scrolling menu displayed on the LCD screen. The commands are then sent to the computer by a wireless transmission system integrated into the stylus. The computer then determines the lighting sources to be powered.

If the stylus is passive, it is possible to provide an ergonomic, preferably “hands free”, interface. The interface may advantageously be achieved by means of a voice command. Once the area to be lit has been designated by the stylus, simple orders then allow the system to be controlled, the computer being responsible for interpreting the commands. Examples of voice commands may be the following:
“Regulating”, for switching to the mode for regulating the lighting, supplemented for example with instructions that specify the regulating;
“Focusing”, for switching to the mode for defining the size of the area lit;
“Plus” or “Minus”, for defining a larger or smaller area;
“High” or “Low”, for defining a higher or lower intensity of the lighting.

In both modes, the invention enables the shadowless lamp to be controlled without requiring the lamp itself to be manipulated. It is also possible to provide the option of lighting well-defined areas with specific lighting parameters, both in terms of color temperature and intensity and notably direction, these lighting parameters being determined by the computer according to the environment, to the type of activity or else to a command delivered by an active stylus. Thus, various parts of the scene would receive light adapted to the activity being carried out. For example, in an operating room, a surgeon requires very strong light with no shadows, whereas an anesthetist instead needs lighting of the daylight type, notably to examine the skin color, an assistant himself requiring screened light. The stylus 2 is the tool that enables an operator to define the lighting direction 5, this direction pointing to the area to be lit. In this way, the lighting sources of the array that illuminate the direction 5 and notably the pointed area will be activated, notably as a priority, before responding to the operator's demands. The number of activated sources and their light intensities will depend on the area to be covered, this area being for example defined by the commands described above.

The invention has been described for a lighting system of the shadowless type. It may also be applicable in other fields, for example for creating ambient lighting or lighting compositions on request. The invention may thus for example be applicable to art galleries or museums, to exhibition halls or to mechanical workshops or even assembly lines.

Advantageously, the invention allows these lighting units to be remotely controlled so as to specify the area to be lit, the assembly direction and the light intensity. This command does not require the light sources to be moved. In the case of a shadowless lamp, the motor drive may thus be eliminated. However, the control method described applies in the same way if certain lighting sources are on motorized supports.

1. A matrix lighting system comprising an array of lighting sources that are activated by a power supply system provided with a processing means said system comprising at least one video sensor and an object comprising marks characterizing the position and the orientation of the object in space, an area to be lit being designated according to the orientation of the object, the sensor capturing the images of the object and transmitting them to the processing means which computes the space coordinates of the marks, the power supply system activating the lighting sources according to the position and the orientation of the object that are defined by the marks.

2. The system as claimed in claim 1, wherein the object has an axis defining the orientation of the object, the area to be lit being pointed to by the straight line from the space coincident with the axis.

3. The system as claimed in claim 2, wherein the object is a stylus, the axis being the axis of the tip of the stylus, the position of the tip of the stylus being known in a reference frame tied to the marks on the stylus.

4. The system as claimed in claim 3, wherein the stylus has a plate on which the marks are placed, the plate being perpendicular to the axis of the tip of the stylus.

5. The system as claimed in claim 1, wherein the marks are reflecting targets.

6. The system as claimed in claim 1, wherein the marks are encoded, the encoding being a function of a given array of lighting sources.

7. The system as claimed in claim 1, wherein since the array of lighting sources is supported by a wall, the wall has an opening via which the sensor observes.

8. The system as claimed in claim 1, wherein when the area to be lit has been designated, the regulating of the area is controlled by means of a voice command transmitted to the system for activating the sources.

9. The system as claimed in claim 1, wherein when the area to be lit has been designated, the regulating of the area is controlled by means of an integrated interface on the object, the regulating command being transmitted to the system for activating the sources via the interface.

10. The system as claimed in claim 1, wherein the array of lighting sources includes marks, the position of which is known in a reference frame tied to this array.

11. The system as claimed in claim 1, wherein the sensor operates in the near infrared.

12. The system as claimed in claim 1, wherein the array of lighting sources belongs to a shadowless lamp.

13. A method of controlling an array of lighting sources that are activated by a power supply system provided with a processing means wherein said method uses at least one video sensor and an object having marks characterizing the position and the orientation of the object in space, an area to be lit being designated according to the orientation of the object, the sensor capturing the images of the object and transmitting them to the processing means which computes the coordinates of the marks in a reference frame tied to the sensor, the power supply system activating the lighting sources as a function of the position and the orientation of the object that are defined by the marks.

14. The method as claimed in claim 13, wherein the object has an axis defining the orientation of the object, the area to be lit being pointed by the straight line from the space coincident with the axis.

15. The method as claimed in claim 13, wherein when the area to be lit has been designated, the regulating of the area is controlled by means of a voice command transmitted to the system for activating the sources.

16. The method as claimed in claim 13, wherein when the area to be lit has been designated, the regulating of the area is controlled by means of an integrated interface on the object, the regulating command being transmitted to the system for activating the sources via the interface.

17. The method as claimed in claim 13, wherein the array of lighting sources belongs to a shadowless lamp.

18. A method of calibrating a video sensor with which an array of lighting sources activated by a power supply system provided with a processing means is equipped, wherein said system comprising at least the sensor and an object having marks characterizing the position and the orientation of the object in space, an area to be lit being designated according to the orientation of the object, the sensor capturing the images of the object and transmitting them to the processing means which computes the space coordinates of the marks with respect to a reference frame tied to the camera, the power supply system activating the lighting sources according to the position and the orientation of the object that are defined by the marks, said calibration method comprises:
a phase during which the sensor points to a test pattern equipped with marks, the position of these marks in space being known relative to a reference frame tied to the test pattern, making it possible to determine the transformation parameters (Rcm, Tern) in order to switch from the reference frame of the test pattern to the reference frame of the sensor;
a phase during which another video sensor points to the marks, the position in space of which is known relative to a reference frame tied to the array of lighting sources, the other sensor also pointing to the marks of the test pattern, making it possible to determine the transformation parameters (Rms, Tms) for switching from the reference frame tied to the test pattern to the reference frame tied to the array of lighting sources; and
a phase for composing the two transformations (Rcm, Tcm, Rms, Tms) for switching from the reference frame tied to the sensor to the reference frame tied to the array of lighting sources.

19. The method as claimed in claim 18, wherein the array of lighting sources belongs to a shadowless lamp.
